(19) United States
(12) Patent Application Publication
(10) Pub. No.: US 2025/0313035 A1
(43) Pub. Date: Oct. 9, 2025

(54) RETRACTABLE CONTAINER

(71) Applicant: Hee Jung LEE, Yongin-si, Gyeonggi-do (KR)

(72) Inventor: Hee Jung LEE, Yongin-si, Gyeonggi-do (KR)

(21) Appl. No.: 18/865,675

(22) PCT Filed: May 12, 2023
(86) PCT No.: PCT/KR2023/006476

§ 371 Date: Nov. 13, 2024

(30) Foreign Application Priority Data
May 16, 2022 (KR) 10-2022-0059623

(51) Int. Cl. B43K 24/08; B43K 7/00

(52) U.S. Cl. CPC B43K 24/088; B43K 7/005

(57) ABSTRACT

The retractable container of the present invention includes a body which accommodates a receptor supported by a spring and a knob configured to deploy and retract the receptor. In the retractable container, the body accommodates the receptor and the spring therein, has an entrance formed on one side thereof and an insertion opening formed on the other side thereof, into which the receptor and the knob are inserted, and comprises a body cam integrally formed with the body and comprising a guide bar which extends from the body to be disposed adjacent to a side of the insertion opening, and the knob is configured to have a feature in which a knock operation part is formed integrally with a protrusion member which connects an extension part and a pressing part inserted into the insertion opening of the body, thus the guide bar of the body cam is moved to respond to a change in position of the knock operation part.

### TECHNICAL Field

The present invention relates to a retractable container in which a receptor of the container is pulled out from a body or retracted into the body by pressing a knob.

### BACKGROUND ART

In general, a container is used to store contents accommodated therein. Recently, various types of retractable structures have been disclosed to simply use and also easily store the contents.

Korean Patent No. 10-2053019 relates to a pen-type cosmetic container configured to push contents by a nozzle through forward movement of a piston, and discloses a structure capable of pushing out or retracting contents injected into the nozzle by moving forward/rearward the piston. However, in the case of this structure, since the configuration of the piston for forward/rearward movement occupies most of the space in the container, there is a disadvantage in that the capacity of the contents is reduced. In addition, in the case of the above structure, there is a problem in that an overall length of the container should be lengthen or a volume thereof should be increased in order to increase the capacity of the contents.

Korean Patent No. 10-1478353 relates to a knock and pressing type writing instrument, wherein in order to perform the knock operation, a number of gears or parts for functioning similar thereto are individually molded therein, and then combined for assembly and operation. In the case of the knock and pressing type writing instrument, since there are many parts for deployment and retraction of a pen lead, the combination structure is complicated during assembly, thus resulting in low productivity and difficulty in managing the parts, and thereby leading to a problem in that the unit price is increased. In addition, since the size of the pen lead is determined in the knock and pressing type writing instrument, there is a disadvantage in that only one product can be used.

Further, since the knock operation configuration for the deployment and retraction of the receptor is positioned inside the container in the known registered patents, there is a problem in that it is difficult to utilize an internal space of the container.

### PRIOR ART DOCUMENT

### Patent Document

(Patent literature 1) KR10-2053019 B
(Patent literature 2) KR10-1478353 B

### SUMMARY OF INVENTION

### Problems to be Solved by Invention

An object of the present invention is to provide a retractable container which may increase productivity and reduce manufacturing costs by simplifying the structure so that a knock operation part, which is a knock operation configuration in the retractable container, is formed in a knob.

In addition, another object of the present invention is to provide a retractable container in which a knock operation configuration is formed on an outside of the container body such that the internal space of the container can be freely used.

### Means for Solving Problems

To achieve the above object, according to an aspect of the present invention, there is provided a retractable container including a body which accommodates a receptor supported by a spring and a knob configured to deploy and retract the receptor, wherein the body accommodates the receptor and the spring therein, has an entrance formed on one side thereof and an insertion opening formed on the other side thereof, into which the receptor and the knob are inserted, and includes a body cam integrally formed with the body and including a guide bar which extends from the body to be disposed adjacent to a side of the insertion opening, and the knob is configured to have a feature in which a knock operation part is formed integrally with a protrusion member which connects an extension part and a pressing part inserted into the insertion opening of the body, thus the guide bar of the body cam moves to respond to a change in position of the knock operation part.

The body cam may include: a first guide slit which accommodates the knock operation part and is movable in a longitudinal direction of the body according to a knock operation; a connection part which connects two guide bars formed at spaced positions by disposing the first guide slit in a center thereof; a projection which protrudes from the guide bar toward the first guide slit and moves along the knock operation part; an auxiliary guide slit formed by a clearance between the guide bar and the body; and a cut-out part formed between the first guide slit and the insertion opening so as to allow the knock operation part to move.

The knock operation part may include: a first slope formed as an inclined surface which widens in a width direction; a cam guide formed to protrude from the inclined surface of the first slope so as to prevent the projection from being deviated when the first slope enters between the projections; a first step formed to extend from the first slope in the longitudinal direction of the body; a second step formed inside an imaginary line extending from the first step; a second slope having an inclined surface formed adjacent to the cam guide in the second step; a placing part formed on a side surface of the cam guide; a third step formed in the longitudinal direction of the body adjacent to the placing part; a third slope having an inclined surface which connects the third step and the fourth step; and a fourth step which connects the third step and the extension part.

A surface of the knock operation part corresponding to the projection in the first step, the second step, the placing part, the third step and the fourth step may be formed as an inclined surface.

The projection may have an inclined surface formed to correspond to the inclined surface of the knock operation part.

The pressing part may include a pressing surface to which a pressure is applied according to the knock operation and a pressing body extending from the pressing surface to form a receptor accommodating space therein, wherein the pressing body may include: a locking projection for fixing the knob after being inserted into the body; a receiving hole formed around the locking projection so as to prevent the locking projection from being latched to the body when the pressing body is inserted into the body; and a first engaging projection formed inside the pressing body so that the receptor is inserted and fixed.

The pressing body may include a second engaging projection formed on an inner peripheral surface thereof such that an outer peripheral surface of the inserted receptor is fitted and fixed thereto.

The body may include a second guide slit formed therein so that the locking projection is inserted and fixed.

The guide bar may be formed in a cantilever type in which one end is connected to the body and the other end is not supported.

According to another aspect of the present invention, there is provided a retractable container including a body which accommodates a receptor supported by a spring and a knob configured to deploy and retract the receptor, wherein the body accommodates the receptor and the spring therein, has an entrance formed on one side thereof and an insertion opening formed on the other side thereof, into which the receptor and the knob are inserted, and includes a body cam integrally formed with the body and including a guide bar which extends from the body to be disposed adjacent to a side of the insertion opening, and the knob is configured to have a feature in which a pressing part inserted into the insertion opening of the body and a knock operation part which protrudes from the pressing part are formed integrally with each other, and the guide bar of the body cam moves to respond to a change in position of the knock operation part.

The body cam may include: a first guide slit which accommodates the knock operation part and is movable in a longitudinal direction of the body according to a knock operation; a connection part which connects two guide bars formed at spaced positions by disposing the first guide slit in a center thereof; a projection which protrudes from the guide bar toward the first guide slit and moves along the knock operation part; and an auxiliary guide slit formed by a clearance between the guide bar and the body, wherein the guide bar is formed in a cantilever type in which one end is connected to the body and the other end is not supported.

The knock operation part may include: a first slope formed as an inclined surface which widens in a width direction; a cam guide formed to protrude from the inclined surface of the first slope so as to prevent the projection from being deviated when the first slope enters between the projections; a first step formed to extend from the first slope in the longitudinal direction of the body; a second step formed inside an imaginary line extending from the first step; a second slope having an inclined surface formed adjacent to the cam guide in the second step; a placing part formed on a side surface of the cam guide; a third step formed in the longitudinal direction of the body adjacent to the placing part; a third slope having an inclined surface which connects the third step and the fourth step; and a fourth step formed in the longitudinal direction of the body on an upper portion of the third step, wherein a surface of the knock operation part corresponding to the projection in the first step, the second step, the placing part, the third step and the fourth step is formed as an inclined surface, and the projection has an inclined surface formed to correspond to the inclined surface of the knock operation part, wherein the pressing part may include a pressing surface to which a pressure is applied according to the knock operation and a pressing body extending from the pressing surface to form a receptor accommodating space therein, wherein the pressing body may include: a locking projection for fixing the knob after being inserted into the body; a receiving hole formed around the knock operation part so as to prevent the knock operation part from being latched to the body when the knock operation part is inserted into the body; a first engaging projection formed inside the pressing body so that the receptor is inserted and fixed thereto; and wherein the pressing body may include a second engaging projection formed on an inner peripheral surface thereof, such that an outer peripheral surface of the inserted receptor is fitted and fixed to the second engaging projection.

### Advantageous Effects

In accordance with the retractable container according to the present invention, the knock operation part is formed integrally with the knob, and the body includes a body cam that moves the knock operation part along according to the knock operation of the knob, thereby the structure may be simplified and productivity may be improved.

In addition, the retractable container of the present invention allows the knob to be easily separated from or coupled to the body through the locking projection and the receiving hole formed in the knob, such that parts of the retractable container may be simply managed.

Further, the retractable container of the present invention allows the knock operation part of the knob, which is a major component for the knock operation, to be positioned on an outside of the retractable container, and first and second engaging projections are formed on the inner peripheral surface of the knob, such that unnecessary space is eliminated inside the retractable container, and receptors having various lengths and thicknesses may be applied to the retractable container and used.

### BRIEF DESCRIPTION OF DRAWINGS

FIG. 1 is a cross-sectional view illustrating a retractable container of the present invention.

FIG. 2 is a perspective view illustrating a body shown in FIG. 1.

FIG. 3A is an enlarged view illustrating the front of a body cam positioned on the body shown in FIG. 2.

FIG. 3B is an enlarged front view illustrating the rear of the body shown in FIG. 3A.

FIG. 4A is an enlarged perspective view illustrating a knob shown in FIG. 1.

FIG. 4B is a side view of the knob shown in FIG. 4A.

FIG. 5 is an enlarged perspective view illustrating a knock operation part shown in FIG. 4A.

FIG. 6A is a perspective view illustrating a moving direction of the projection in the knock operation part shown in FIG. 4A.

FIG. 6B is views illustrating moving points of the projection during the knock operation process from a basic position of the retractable container before a knock operation while the receptor is retracted into the body.

FIG. 7 is a perspective view illustrating another embodiment of the retractable container of the present invention.

FIG. 8A is a plan view (A), a front view (B), and a bottom view (C) illustrating another embodiment of the retractable container of the present invention, and FIG. 8B is an enlarged perspective view illustrating the knob.

### MODE FOR CARRYING OUT INVENTION

Hereinafter, the present invention will be described with reference to the accompanying drawings. However, the present invention may be implemented in various different forms, and therefore, is not limited to the embodiments described herein.

Throughout this specification, when it will be described that a portion is “connected (linked, contacts or coupled)” to another portion, the portion may be “directly connected (linked, contact or coupled)” to the other portion or “indirectly connected (linked, contact or coupled)” with the other member interposed therebetween. In addition, when it will be described that a portion “comprises or includes” a component, this means that the part may further include other components without excluding the other components, unless there is a description opposite thereto.

In addition, the terminology used in the present disclosure is for the purpose of describing particular embodiments only and is not intended to limit the present invention thereto. As used herein, the singular forms “a,” “an” and “the” are intended to include the plural forms as well, unless the context clearly indicates otherwise. It should be further understood that the terms “comprises,” “comprising,” “includes” and/or “including,” described in the present disclosure, specify the presence of stated features, integers, steps, operations, elements, components or a combination thereof, but do not preclude the presence or addition of one or more other features, integers, steps, operations, elements, components, or a combination thereof.

Preferred embodiments of the present invention will be described in detail with reference to the accompanying drawings, so that persons having common knowledge in the technical field to which the present invention pertains can easily implement the invention based on the technical spirit thereof.

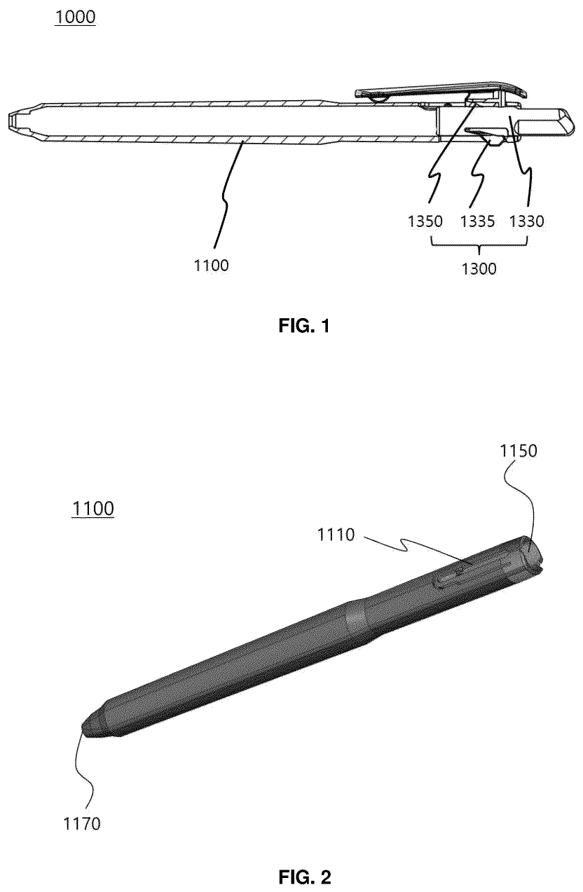

FIG. 1 is a cross-sectional view illustrating a retractable container 1000 of the present invention.

The retractable container 1000 includes a body 1100 and a knob 1300. To describe an operation of the retractable container 1000, a receptor (not shown) formed inside the body 1100 is deployed from the body or retracted into the body due to a knock operation of the knob 1300. The knock operation requires compression and a restoring force of a spring (not shown). The present invention is characterized in that a configuration necessary for the knock operation is formed on an outside the body 1100 so that an internal space of the body 1100 may be utilized.

In addition, the knob 1300 includes a knock operation part 1350, a pressing part 1330, and a locking projection 1335 which are integrally formed with the knob. In the case of the knob 1300, the respective components are formed as a single-molded product to simplify the structure, thereby improving productivity and reducing manufacturing costs.

In the following description, an entrance 1170 side of the body 1100 will be described as the front end, and a side into which the knob 1300 is inserted will be described as the rear end.

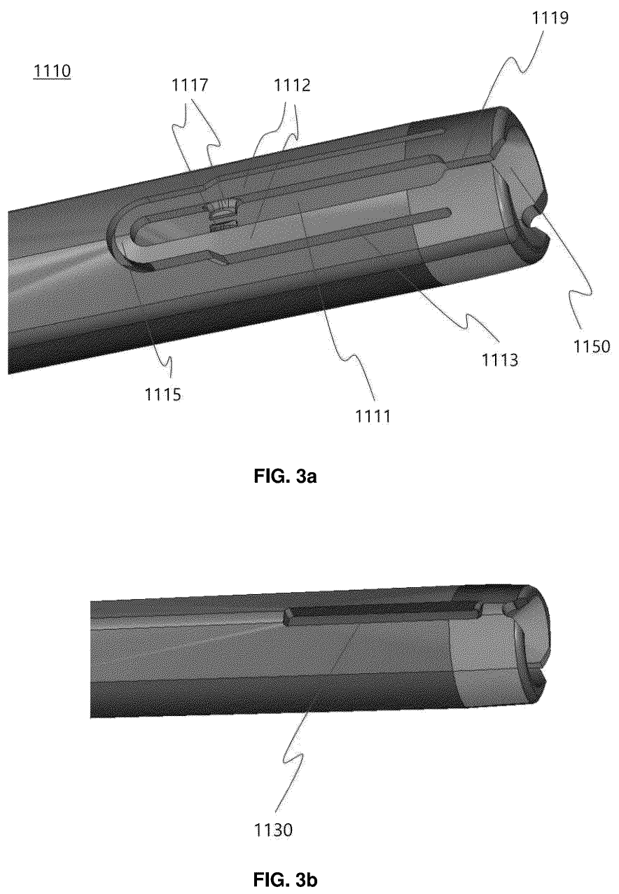

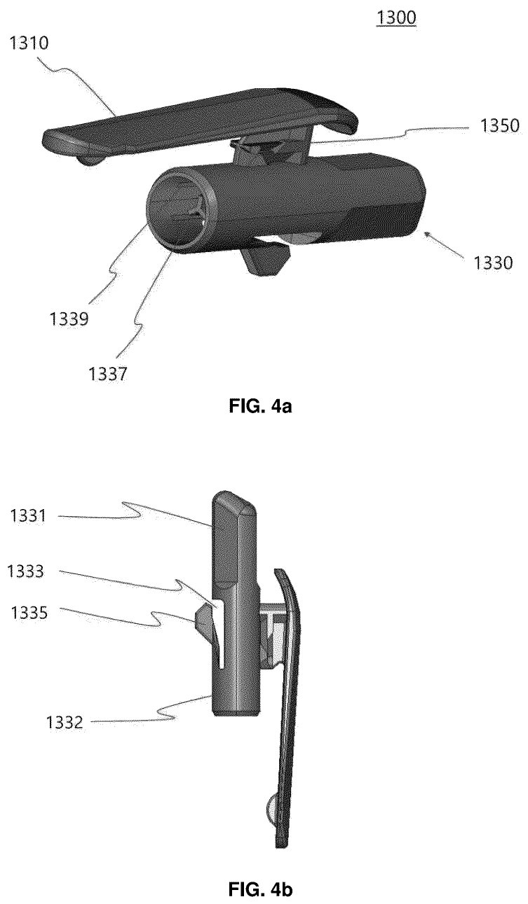

FIG. 2 is a perspective view illustrating the body 1100 shown in FIG. 1. FIG. 3A is an enlarged view illustrating the front of a body cam 1110 positioned in the body 1100 shown in FIG. 2. FIG. 3B is an enlarged view illustrating the rear of the body 1100 shown in FIG. 3A.

The body 1100 includes the body cam 1110, a second guide slit 1130, an insertion opening 1150, and the entrance 1170. The body 1100 is formed integrally as a whole, and has a space defined therein, in which the receptor (not shown) and the spring (not shown) are accommodated. The body 1100 has the entrance 1170 formed on one side thereof, and the insertion opening 1150 formed on the other side, into which the receptor (not shown) and the knob 1300 can be inserted. The body 1100 does not include parts necessary for the knock operation to deploy and retract the receptor (not shown). Therefore, the internal space may be freely utilized. The expression “the internal space of the body 1100 may be freely utilized” means that the receptor (not shown) can be used without limitation in the size (thickness or length).

Referring to FIGS. 2 to 3A, the body cam 1110 includes a first guide slit 1111, a guide bar 1112, an auxiliary guide slit 1113, a connection part 1115, a projection 1117 and a cut-out part 1119.

The body cam 1110 has a lever shape with a plurality of slits in the body 1100 to respond to a change in position of the knock operation part 1350. In particular, the body cam 1110 may be formed as a cantilever type in which one end of the lever is connected to the body 1100 and the other end is not supported. This body cam 1110 controls the position (deployed from the body or retracted into the body) of the receptor (not shown) while moving along the knock operation part 1350 by the knock operation of the retractable container 1000.

The first guide slit 1111 is a through hole formed in a longitudinal direction of the body 1100 and accommodates the knock operation part 1350. The knock operation part 1350 moves in the longitudinal direction of the body 1100 according to the knock operation.

In is characterized in that the guide bar 1112 is a lever formed on one or both sides about the first guide slit 1111. When the guide bar 1112 is formed on one side as a single type, it may be formed in the cantilever type in which one end of the guide bar 1112 is fixed to the body 1100 on one side of the first guide slit 1111 and the other end of the guide bar 1112 is not supported. When the guide bar 1112 is formed on both sides as a double type, two guide bars 1112 of the cantilever type are formed on both sides about the first guide slit 1111. At this time, the respective ends of the two guide bars 1112 that are not supported may be formed by being connected with each other.

The auxiliary guide slit 1113 is a hole formed between the guide bar 1112 and the body 1100. The auxiliary guide slit 1113 is a hole formed so that the guide bar 1112 can move along the knock operation part 1350. In addition, a width of the auxiliary guide slit 1113 defines a clearance that can respond to the change in the position of the guide bar 1112.

The connection part 1115 connects two guide bars 1112. The connection part 1115 is formed so as to maintain a pressure or force applied to the guide bars 1112 when the width between the two guide bars 1112 are increased or decreased. The connection part 1115 connects the two guide bars 1112 without breaking even when the position of the knock operation part 1350 changes according to the knock operation, the width between the two guide bars 1112 is increased, or the height of at least one guide bar 1112 changes. In the present invention, it is illustrated that the connection part 1115 is formed in a U shape, but it may be implemented by modifying the connection shape and a thickness of the connection part differently (thinner or thicker) so as to connect the two guide bars 1112 disposed at spaced locations and maintain the pressure applied thereto.

The projection 1117 protrudes from the guide bar 1112 in a direction of the first guide slit 1111. The projection 1117 is characterized by moving along the knock operation part 1350 during the knock operation. In particular, the projection 1117 may move along a plurality of inclined surfaces and a plurality of steps formed in the knock operation part 1350 or be fixed thereto. A surface of the projection 1117 corresponding to the knock operation part 1350 may be formed as an inclined surface so as to prevent the knock operation part 1350 from being deviated in a traveling direction thereof during the knock operation. Although the present invention illustrates that the projection 1117 is formed in a symmetrical position in the direction of the first guide slit 1111 on the two guide bars 1112 disposed at the spaced positions, it may be implemented by modifying so that at least one projection 1117 is disposed at the spaced position along the inclined surface and steps of the knock operation part 1350.

The cut-out part 1119 is formed between the first guide slit 1111 and the insertion opening 1150 at the rear end portion of the body 1100. The cut-out part 1119 provides a passageway for the knock operation part 1350 when the knob 1300 is inserted into or separated from the body 1100. In order for the knob 1300 to be easily inserted into the body 1100 during the inserting process, the cut-out part 1119 may be formed diagonally so that ends thereof connected to the insertion opening 1150 are increased in width in a direction of the insertion opening 1150. In addition, the cut-out part 1119 may offset the pressure applied to the connection part 1115 during the knock operation by the clearance formed between the first guide slit 1111 and the insertion opening 1150.

The second guide slit 1130 is a through hole formed in the longitudinal direction of the body 1100, into which a portion of the knob 1300 can be inserted and fixed. The locking projection 1335 may be inserted into the second guide slit 1130. FIG. 3B illustrates that the second guide slit 1130 is formed on the opposite side of the body cam 1110 at the rear end of the body 1100, but it may be formed at a location which does not overlap with the body cam 1110 on an outer peripheral surface of the body 1100.

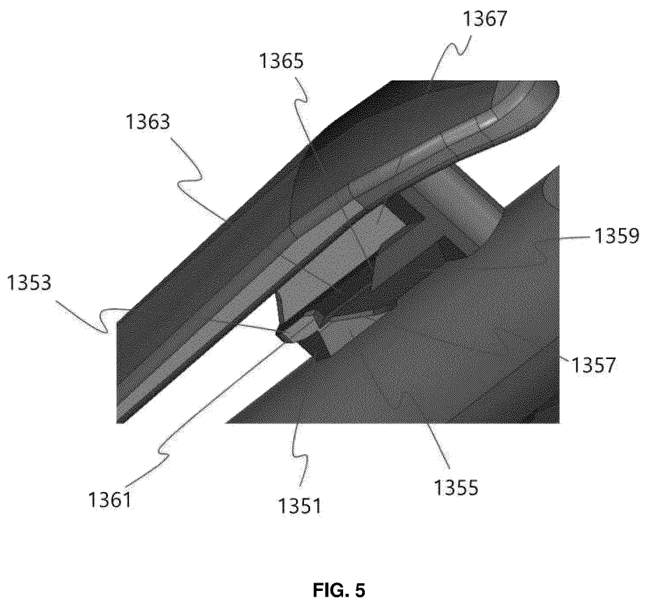

FIG. 4A is an enlarged perspective view illustrating the knob 1300 shown in FIG. 1. FIG. 4B is a side view illustrating the knob 1300 shown in FIG. 4A.

The knob 1300 includes an extension part 1310, the pressing part 1330, and the knock operation part 1350. The knob 1300 is characterized by being formed as a single molding, and in particular, is characterized in that the knock operation part 1350 is formed integrally therewith. The knob 1300 is inserted into the insertion opening 1150 of the body 1100, and then moves forward or backward according to the knock operation. In the knob 1300, the knock operation part 1350 is formed at a connection part which connects the pressing part 1330 and the extension part 1310. That is, in the present invention, the configuration necessary for the knock operation is not formed inside the body 1100, such that various receptors (not shown) may be applied and used without limitation in the size, thickness and length of the receptors (not shown).

After the knob 1300 is coupled to the body 1100, the extension part 1310 allows a user to carry the retractable container 1000 by inserting it into a pocket or the like.

The pressing part 1330 includes a pressing surface 1331, a pressing body 1332, a receiving hole 1333, the locking projection 1335, a first engaging projection 1337, and a second engaging projection 1339. The pressing part 1330 may be a portion to which a pressure required for the knock operation is applied.

The pressing 1331 is a portion which is pressed by the user's hand during the knock operation. Looking at an operational relationship in the retractable container 1000 of the present invention, when pressing the pressing surface 1331, the receptor (not shown) is deployed from the entrance 1170, and when pressing the pressing surface 1331 again, the receptor (not shown) may be retracted into the entrance 1170.

The pressing body 1332 is an area which extends from the pressing surface 1331 and is inserted into the insertion opening 1150 of the body 1100. The pressing body 1332 includes the locking projection 1335 to fix the body 1100 and the knob 1300. The pressing body 1332 has a receptor accommodating space formed in a center thereof so that the receptor (not shown) can be coupled.

In addition, the pressing body 1332 includes the locking projection 1335 which is inserted into the second guide slit 1130 to fix the body 1100 and the knob 1300 to each other. The locking projection 1335 includes the receiving hole 1333 formed around the locking projection 1335 in the pressing body 1332. Therefore, when inserting the locking projection 1335 into the body 1100, it is inserted into the body 1100 in a pressed state and then fixed while the locking projection 1335 is fitted into the second guide slit 1130. Conversely, when separating the knob 1300 from the body 1100, the locking projection 1335 is pressed so as to be removed from the second guide slit 1130. The locking projection 1335 is characterized by having a cantilever shape in which one end is fixedly connected to the pressing body 1332 and the other end is not fixed so as to allow the shape to be changed when pressed, and to be restored to an original position when the pressing is released. The locking projection 1335 may have an oblique shape in which a front surface is raised toward a rear end so that it can be easily pressed against the body 1100 when entering the receiving hole 1333.

The receptor accommodating space of the pressing body 1332 includes the first engaging projection 1337 and the second engaging projection 1339. The pressing body 1332 includes the first engaging projection 1337 which is inserted and fixed to an inner peripheral surface of a content accommodating part of the receptor (not shown) so that various receptors (not shown) may be applied and used without limitations in the size, thickness and length of the receptor (not shown), and is formed inside the pressing body 1332. In addition, the pressing body 1332 includes the second engaging projection 1339 on formed the inner peripheral surface thereof, which is fitted adjacent to an outer peripheral surface of the receptor (not shown). For example, when the receptor (not shown) has a narrow cross-section, it may be used by fitting it into the first engaging projection 1337. In addition, when the receptor (not shown) has a wide cross-section or the receptor is blocked, it is possible to use by fitting the outer peripheral surface of the receptor to the second engaging projection 1339. Further, in the receptor accommodating space of the pressing body 1332 of the present invention, a receptor (not shown) having a long or short length depending on the arrangement of the first engaging projection 1337 and the second engaging projection 1339 may be used, such that the usability of the receptor (not shown) is increased.

The container of the present invention is characterized by including the first engaging projection formed so that the receptor is inserted into the pressing body and fixed thereto.

The container of the present invention is characterized by including the second engaging projection formed on the inner peripheral surface of the pressing body so that the outer peripheral surface of the inserted receptor is fitted and fixed thereto.

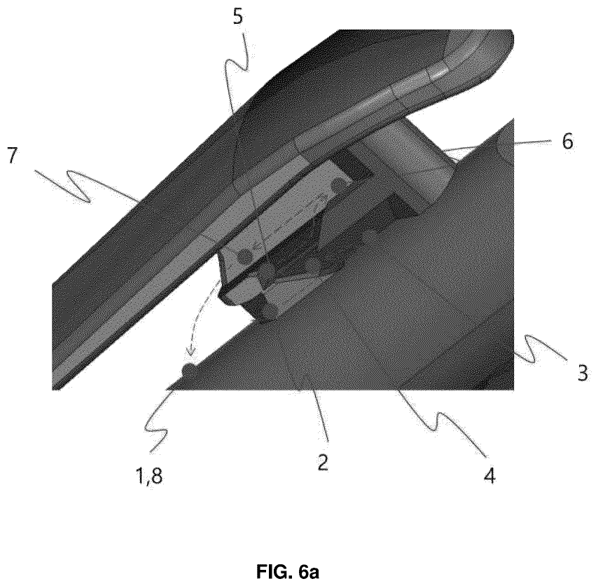

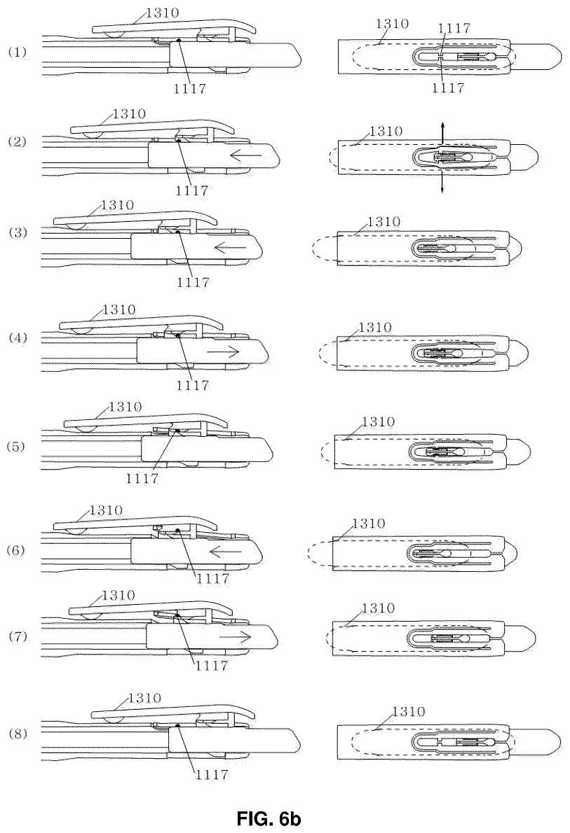

FIG. 5 is an enlarged perspective view illustrating the knock operation part 1350 shown in FIG. 4A. FIG. 6A is a view illustrating a moving direction of the projection in the knock operation part: shown in FIG. 4A. FIG. 6B illustrates moving Points (2 to 7) of the projection 1117 starting from basic Position 1 of the retractable container 1000 during the knock operation, before the knock operation, while the receptor (not shown) is retracted into the body 1100. At this time, the basic Position 1 means a state where the projection 1117 is disposed at a distance spaced apart from the knock operation part 1350.

The knock operation part 1350 includes a first slope 1351, a cam guide 1353, a first step 1355, a second slope 1357, a second step 1359, a placing part 1361, a third step 1363, a third slope 1365 and a fourth step 1367. The knock operation part 1350 is characterized in that a plurality of slopes and a plurality of steps are formed integrally with each other.

The knock operation part 1350 moves forward from the rear end or rearward from the front end in the longitudinal direction of the body 1100 according to the knock operation. At this time, the projection 1117 of the body cam 1110 is positioned on the slope or step of the knock operation part 1350. Looking at the arrangement of the plurality of slopes and steps in the knock operation part 1350, the projection 1117 is lifted adjacent to the extension part 1310 on the outside based on the body 1100 or is displaced in the original position (body 1100 position). As a result, in the retractable container 1000 of the present invention, the configuration related to the knock operation is not disposed in the internal space of the body 1100, such that the usability of the internal space is increased.

The knock operation part 1350 may be formed in the same shape on both sides corresponding to the body cam 1110. In the present invention, it is illustrated that the knock operation part 1350 is formed on both sides, but it is characterized in that the knock operation may be performed even if it is formed on only one side.

The first slope 1351 is formed as an inclined surface which widens in a width direction. The first slope 1351 allows the projection 1117 moves in a direction opposite to the pressure applied by the knock operation. As the projection 1117 moves along the inclined surface of the first slope 1351 which widens in the width direction, a width between the two guide bars 1112 is increased.

The cam guide 1353 is disposed on the first slope 1351 and is formed to protrude from the inclined surface of the first slope 1351. The cam guide 1353 prevents the projection 1117 from being deviated when the first slope 1351 enters between the projections 1117.

The first step 1355 is formed to extend from the first slope 1351 in the longitudinal direction of the body 1100. The first step 1355 guides the projection 1117 to the end of the first step 1355 while maintaining the width between the two guide bars 1112 at Point 2 where the first slope 1351 ends in the direction opposite to the pressure applied to the pressing surface 1331.

The second step 1359 is characterized by being formed inside an imaginary line (not shown) extending from the first step 1355. The second step 1359 further includes an inclined surface or a guide groove. The second step 1359 may be formed so that the inclined surface protrudes toward an upper end from a lower end in the width direction to prevent the projection 1117 from being deviated during the knock operation. Since the inclined surface of the second step 1359 is disposed inside the imaginary line (not shown) extending from the first step 1355, the gap between the two guide bars 1112 of the body cam 1110 is restored by the projection 1117. The second step 1359 causes the pressure applied to the pressing surface 1331 during the knock operation to be maximum so that the receptor (not shown) compresses the spring (not shown) to the maximum, and thereby the projection 1117 becomes Position 3 adjacent to the end of the second step 1359. In addition, the expression “the pressure applied to the pressing surface 1331 during the knock operation to be maximum” means a state where the largest portion of the knob 1300 is retracted into the body 1100. At this time, if the front end of the knock operation part 1350 comes into contact with the front end of the first guide slit 1111 or the locking projection 1335 comes into contact with the front end of the second guide slit 1130, the knob 1300 may no longer move forward.

When the pressure applied to the pressing surface 1331 during the knock operation reaches the maximum, then the pressure is removed (one knock operation is completed), the knob 1300 is pushed to the rear end of the body 1100 by the reaction of the spring (not shown). In this state, a traveling direction of the projection 1117 is changed (4).

The second slope 1357 is characterized by having an inclined surface formed adjacent to the cam guide 1353 at the second step 1359. The second slope 1357 causes the projection 1117 to move along the inclined surface at the second step 1359 after the traveling direction is changed. The projection 1117 moves along the second slope 1357 to raise the two guide bars 1112 and the connection part 1115 which connects them adjacent to the extension part 1310.

In FIG. 6A, Point 5 where the projection 1117 is disposed on the placing part 1361 in 6A indicates a state where the knob 1300 is no longer pushed rearward and is fixed, and the receptor 1500 is deployed outside the body 1100 thus can be used. That is, the placing part 1361 causes the projection 1117 to be latched so that the knob 1300 is fixed to the body 1100. The placing part 1361 is formed on a side surface of the cam guide 1353, and may be formed as an inclined surface whose width is increased toward the upper portion adjacent to the extension part 1310 so as to prevent the projection 1117 from being deviated. In addition, the projection 1117 may have an inclined surface formed at a portion in contact with the inclined surface of the placing part 1361 corresponding to the inclined surface of the placing part 1361.

In FIG. 6A, Point 6 represents a state where the knob 1300 is pressed to retract the receptor (not shown) that is deployed outside the body 1100 into the body 1100, and the traveling direction of the projection 1117 is changed at this point.

The third step 1363 moves the projection 1117 in the longitudinal direction of the body 1100 according to the pressure applied to the pressing surface 1331 by the knock operation. The third step 1363 is formed as an inclined surface, such that the projection 1117 passes through the third slope 1365 which connects the third step 1363 and the fourth step 1367, and moves to Position 6 adjacent to the fourth step 1367.

The fourth step 1367 connects the third step 1363 and the extension part 1310. In addition, the fourth step 1367 causes the projection 1117 to change its traveling direction and move (7) to the front end of the knock operation part 1350 while the knob 1300 is pushed to the rear end of the body 1100. In FIG. 6A, Point 7 indicates the position of the projection 1117 in a state where the knob 1300 is no longer pressed during the knock operation, such that the knob 1300 is pushed to the rear end of the body 1100 by the reaction of the spring (not shown).

In FIG. 6A, Point 8 indicates the position of the projection 1117 in a state where the receptor 1500 is retracted into the body 1100, and is the same as initial Point 1 before the operation.

In the retractable container 1000 of the present invention, the knock operation part 1350 of the knob 1300, which is the major component for the knock operation, is formed on the outside the body 1100. Therefore, as described above, the internal space of the container may be freely used. As in the present invention, when the usability of the container body 1100 is increased, receptors (not shown) having various lengths and thicknesses may be used, such that the inconvenience of the container becoming unnecessarily long or having to use only a specific receptor may be improved.

In addition, the retractable container 1000 of the present invention is characterized in that the knock operation part 1350 is formed integrally with the knob 1300, and the body cam 1110 which moves along the knock operation part 1350 is formed integrally with the body 1100, thereby simplifying the structure. That is, the retractable container may be used for writing instruments, cosmetics, sanitary products, diagnostic kits, etc., and may be used in various fields as medical, industrial, and such stationery, etc.

For example, when the retractable container 1000 is applied to a retractable writing instrument, there is no limitation in the size, thickness or length of the inserted pen lead, such that the internal space may be freely utilized. Specifically, pen lead receptors having different thicknesses or pen leads having different lengths may be applied to the retractable container 1000 and used. In addition, since the retractable container 1000 may be formed with a single molding of the retractable configuration, productivity may be improved and production costs may be reduced.

In addition, as another embodiment, when the retractable container 1000 of the present invention is applied to a retractable cosmetic case in which a brush or puff is deployed and retracted, there is no limitation in the size, thickness or length of the receptor in which the cosmetic is accommodated and connected to the brush or puff, etc., which is inserted into the retractable container, such that the internal space may be freely utilized.

As another embodiment, when the retractable container 1000 of the present invention is applied to a toothbrush storage container from which a toothbrush is deployed and retracted, there is no limitation in the size, thickness or length of the inserted pen lead, such that the internal space may be freely utilized. Therefore, the container may be utilized for portable use.

As another embodiment, when the retractable container 1000 of the present invention is applied to a retractable diagnostic device in which a stick for absorbing a sample is deployed and retracted, there is no limitation in the size, thickness or length of the inserted diagnostic device, such that the internal space may be freely utilized. Specifically, diagnostic devices having different thicknesses or different lengths may be applied to the retractable container 1000 and used.

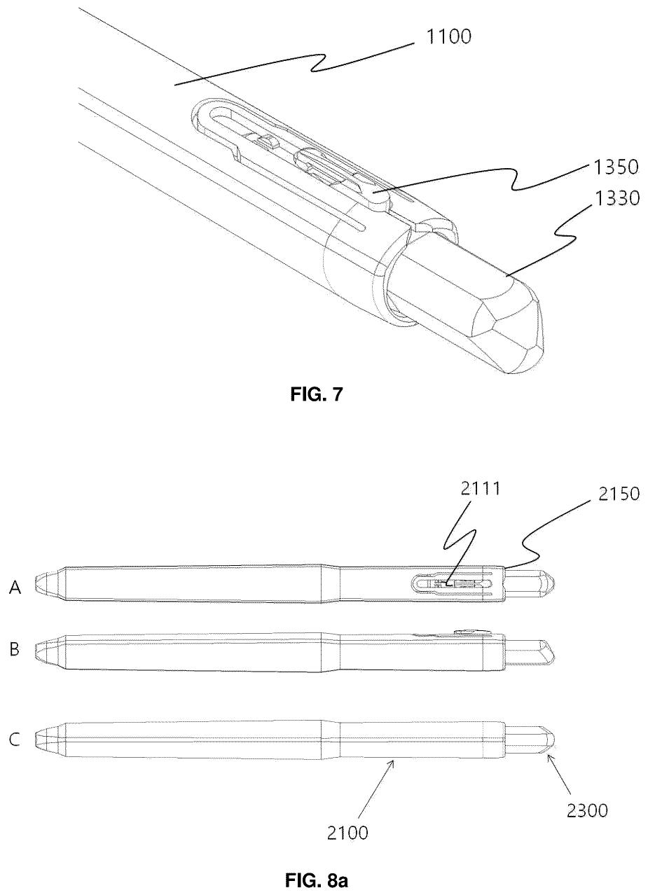

FIG. 7 is a perspective view illustrating another embodiment of the retractable container of the present invention. In the present invention, a product that does not need to be carried by inserting the retractable container 1000 into a pocket or the like may be implemented by removing the extension part 1310 and changing the shape so that the exterior has a smooth appearance.

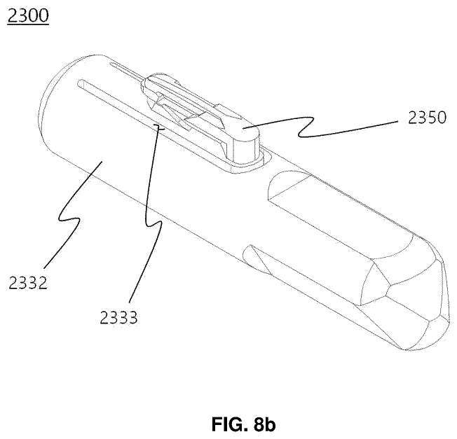

FIG. 8A is a plan view (A), a front view (B), and a bottom view (C) illustrating another embodiment of the retractable container of the present invention, and FIG. 8B is an enlarged perspective view illustrating the knob.

FIGS. 8A and 8B have the same function related to the knock operation of deploying the receptor (not shown) accommodated inside the body 1100 to the outside the body 1100 by pressing the knob 1300 as FIGS. 1 to 6B, and therefore will not be described in detail. Compared to the configurations of FIGS. 1 to 6B, FIGS. 8A and 8B have different structures of a knock operation part 2350 including a locking projection 1335 and a body 2100 corresponding thereto, and therefore will be described focus on the parts related thereto.

The knock operation part 2350 is inserted into a first guide slit 2111 of the body 2100 through an insertion opening 2150. The knock operation part 2350 is characterized by being a cantilever type in which a receiving hole 2333 is formed around the periphery, such that one end is connected to the pressing body 2332 and the other end is not supported.

The knock operation part 2350 is inserted while being pressed into the pressing body 2332, thereby preventing it from being latched to the body 2100. After being inserted, the knock operation part 2350 recovers from the state where it was pressed into the pressing body 2332, thus to protrude outwardly from the body 2100. At this time, the knock operation part 2350 is latched to the first guide slit 2111, thereby preventing the knob 2300 from coming off the body 2100. When removing the knob 2300 from the body 2100, the knock operation part 2350 is pressed into the pressing body 2332 so that it is not latched to the body 2100. At this time, the knob 2300 is removed from the body 2100 through the insertion opening 2150.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### Description of Reference Numerals

1000: Retractable container
1100: Body
1110: Body cam
1111: First guide slit
1112: Guide bar
1113: Auxiliary guide slit
1115: Connection part
1117: Projection
1119: Cut-out part
1130: Second guide slit
1150: Insertion opening
1170: Entrance
1300: Knob
1310: Extension part
1330: Pressing part
1331: Pressing surface
1332: Pressing body
1333: Receiving hole
1335: Locking projection
1337: First engaging projection
1339: Second engaging projection
1350: Knock operation part
1351: First slope
1353: Cam guide
1355: First step
1357: Second slope
1359: Second step
1361: Placing part
1363: Third step
1365: Third slope
1367: Fourth step
2100: Body
2111: First guide slit
2150: Insertion opening
2300: Knob
2332: Pressing body
2333: Receiving hole
2350: Knock operation part

### Sequence List Free Text

No

1. A retractable container comprising a body which accommodates a receptor supported by a spring and a knob configured to deploy and retract the receptor,
wherein the body accommodates the receptor and the spring therein, has an entrance formed on one side thereof and an insertion opening formed on the other side thereof, into which the receptor and the knob are inserted, and comprises a body cam integrally formed with the body and comprising a guide bar which extends from the body to be disposed adjacent to a side of the insertion opening, and
the knob is configured to have a feature in which a knock operation part is formed integrally with a protrusion member which connects an extension part and a pressing part inserted into the insertion opening of the body, thus the guide bar of the body cam moves to respond to a change in position of the knock operation part.

2. The retractable container according to claim 1, wherein the body cam comprises:
a first guide slit which accommodates the knock operation part and is movable in a longitudinal direction of the body according to a knock operation;
a connection part which connects two guide bars formed at spaced positions by disposing the first guide slit in a center thereof;
a projection which protrudes from the guide bar toward the first guide slit and moves along the knock operation part;
an auxiliary guide slit formed by a clearance between the guide bar and the body; and
a cut-out part formed between the first guide slit and the insertion opening so as to allow the knock operation part to move.

3. The retractable container according to claim 1, wherein the knock operation part comprises:
a first slope formed as an inclined surface which widens in a width direction;
a cam guide formed to protrude from the inclined surface of the first slope so as to prevent the projection from being deviated when the first slope enters between the projections;
a first step formed to extend from the first slope in the longitudinal direction of the body;
a second step formed inside an imaginary line extending from the first step;
a second slope having an inclined surface formed adjacent to the cam guide in the second step;
a placing part formed on a side surface of the cam guide;
a third step formed in the longitudinal direction of the body adjacent to the placing part;
a third slope having an inclined surface which connects the third step and the fourth step; and
a fourth step which connects the third step and the extension part.

4. The retractable container according to claim 3, wherein a surface of the knock operation part corresponding to the projection in the first step, the second step, the placing part, the third step and the fourth step is formed as an inclined surface.

5. The retractable container according to claim 3, wherein the projection has an inclined surface formed to correspond to the inclined surface of the knock operation part.

6. The retractable container according to claim 1, wherein the pressing part comprises a pressing surface to which a pressure is applied according to the knock operation and a pressing body extending from the pressing surface to form a receptor accommodating space therein,
wherein the pressing body comprises:
a locking projection for fixing the knob after being inserted into the body; a receiving hole formed around the locking projection so as to prevent the locking projection from being latched to the body when the pressing body is inserted into the body; and
a first engaging projection formed inside the pressing body so that the receptor is inserted and fixed.

7. The retractable container according to claim 6, wherein the pressing body comprises a second engaging projection formed on an inner peripheral surface thereof such that an outer peripheral surface of the inserted receptor is fitted and fixed thereto.

8. The retractable container according to claim 6, wherein the body comprises a second guide slit formed therein so that the locking projection is inserted and fixed.

9. The retractable container according to claim 1, wherein the guide bar is formed in a cantilever type in which one end is connected to the body and the other end is not supported.

10. A retractable container comprising a body which accommodates a receptor supported by a spring and a knob configured to deploy and retract the receptor,
wherein the body accommodates the receptor and the spring therein, has an entrance formed on one side thereof and an insertion opening formed on the other side thereof, into which the receptor and the knob are inserted, and comprises a body cam integrally formed with the body and comprising a guide bar which extends from the body to be disposed adjacent to a side of the insertion opening, and
the knob is configured to have a feature in which a pressing part inserted into the insertion opening of the body and a knock operation part which protrudes from the pressing part are formed integrally with each other, and
the guide bar of the body cam moves to respond to a change in position of the knock operation part.

11. The retractable container according to claim 10, wherein the body cam comprises:
a first guide slit which accommodates the knock operation part and is movable in a longitudinal direction of the body according to a knock operation;
a connection part which connects two guide bars formed at spaced positions by disposing the first guide slit in a center thereof;
a projection which protrudes from the guide bar toward the first guide slit and moves along the knock operation part; and
an auxiliary guide slit formed by a clearance between the guide bar and the body,
wherein the guide bar is formed in a cantilever type in which one end is connected to the body and the other end is not supported.

12. The retractable container according to claim 10, wherein the knock operation part comprises:
a first slope formed as an inclined surface which widens in a width direction;
a cam guide formed to protrude from the inclined surface of the first slope so as to prevent the projection from being deviated when the first slope enters between the projections;
a first step formed to extend from the first slope in the longitudinal direction of the body;
a second step formed inside an imaginary line extending from the first step;
a second slope having an inclined surface formed adjacent to the cam guide in the second step;
a placing part formed on a side surface of the cam guide;
a third step formed in the longitudinal direction of the body adjacent to the placing part;
a third slope having an inclined surface which connects the third step and the fourth step; and
a fourth step formed in the longitudinal direction of the body on an upper portion of the third step,
wherein a surface of the knock operation part corresponding to the projection in the first step, the second step, the placing part, the third step and the fourth step is formed as an inclined surface, and the projection has an inclined surface formed to correspond to the inclined surface of the knock operation part,
wherein the pressing part comprises a pressing surface which a pressure is applied according to the knock operation and a pressing body extending from the pressing surface to form a receptor accommodating space therein,
wherein the pressing body comprises:
a locking projection for fixing the knob after being inserted into the body; a receiving hole formed around the knock operation part so as to prevent the knock operation part from being latched to the body when the knock operation part is inserted into the body;
a first engaging projection formed inside the pressing body so that the receptor is inserted and fixed thereto; and
wherein the pressing body comprises a second engaging projection formed on an inner peripheral surface thereof, such that an outer peripheral surface of the inserted receptor is fitted and fixed to the second engaging projection.
